(19) United States
(12) Patent Application Publication
(10) Pub. No.: US 2015/0284556 A1
(43) Pub. Date: Oct. 8, 2015

(54) PHOTOPOLYMERIZABLE MOLDING RESIN COMPOSITION AND MOLDED MULTILAYER ARTICLE

(71) Applicant: DIC CORPORATION, Tokyo (JP)

(72) Inventors: Masashi Sugiyama, Ichihara-shi (JP); Nobuo Kobayashi, Ichihara-shi (JP)

(73) Assignee: DIC CORPORATION, Tokyo (JP)

(21) Appl. No.: 14/439,452

(22) PCT Filed: Oct. 24, 2013
(86) PCT No.: PCT/JP2013/078848

§ 371 Date: Apr. 29, 2015

(30) Foreign Application Priority Data
Oct. 31, 2012 (JP) 2012-240362

(51) Int. Cl. C08L 33/08; C08L 33/14; G02B 1/04; C08L 35/02

(52) U.S. Cl. CPC C08L 33/08; C08L 35/02; C08L 33/14; G02B 1/041

(57) ABSTRACT

There are provided a photocurable molding resin composition that exhibits a high adhesion to a variety of transparent resin substrates when formed into a resin layer on the transparent resin substrate, and a molded multilayer article having high adhesion between the resin layer and the transparent substrate. The composition contains a photopolymerizable substance (A) having a (meth)acryloyl group in the molecule thereof, a hydrogen abstraction type photopolymerization initiator (B), an intramolecular cleavage type photopolymerization initiator (C), and a silicone compound (D). The proportion of the silicone compound (D) is 1.0 to 5.0 parts by mass to the total mass of the composition that is 100 parts by mass of the constituents (A) to (C).

### TECHNICAL FIELD

The present invention relates to a photocurable molding resin composition suitable for Fresnel lens sheets or lenticular sheets used in projection screens of projection TVs or the like, prism sheets or microlens sheets used as backlights of liquid crystal display devices or the like, and moth-eye films or the like used as antireflection films of flat-screen TVs, and to a molded multilayer article produced by molding the resin composition.

### BACKGROUND ART

An optical sheet having a micro-textured surface is essential for the display of recent liquid crystal display devices and other displays. In the display, the micro-textured structure refracts light to produce a desired function, and the optical sheet is required to have a high refractive index and shape retention capability. Exemplary optical sheets include Fresnel lens sheets and lenticular sheets used in projection screens of projection TVs or the like, prism sheets and microlens sheets used as backlights of liquid crystal display devices or the like, and moth-eye films or the like having recently been attracting attention as antireflection films of flat-screen TVs.

Such an optical sheet, for example, a prism sheet (optical sheet) used as a backlight of a liquid crystal display device or the like, is in the form of a molded multilayer article including a micro-textured resin layer having an optical function on a transparent resin substrate. The optical sheet is formed by applying a photopolymerizable composition to a micro-textured mold, smoothing the surface of the composition, superposing a transparent resin substrate on the composition, and then irradiating the composition with an active energy radiation through the transparent resin substrate to cure the composition.

The thus formed multilayer article is generally inferior in adhesion between the transparent resin substrate and the micro-textured resin layer. It is desired to improve the adhesion. In this regard, in the field of hard coating where a shaping process step is not performed, some techniques are known for improving the adhesion between a cured product and a substrate. For example, the following PTL 1 discloses a technique using a photopolymerization initiator having a hydrogen abstraction type chemical structure for improving the adhesion to the substrate film. In such a field using paint, interaction occurs relatively easily at the interface with the substrate. On the other hand, it is difficult to apply the technique for improving adhesion in the field using paint to the field of shaping without modification, because shaped materials have certain thicknesses.

### CITATION LIST

### Patent Literature

PTL 1: Japanese Unexamined Patent Application Publication No. 2002-275392

### SUMMARY OF INVENTION

### Technical Problem

Accordingly, an object of the present invention is to provide a photocurable molding resin composition that exhibits a high adhesion to a variety of transparent resin substrates when a resin layer is formed on the transparent resin substrate, and a molded multilayer article having high adhesion between the resin layer and the substrate.

### Solution to Problem

The present inventors have found, through their intensive research for solving the above-described problem, that the adhesion to a variety of transparent resin substrates is dramatically increased by using a hydrogen abstraction type photopolymerization initiator and an intramolecular cleavage type photopolymerization initiator in combination as a photopolymerization initiator in a photocurable molding resin composition, and adding a specific amount of a silicone compound as an additive to the resin composition, and thus have accomplished the present invention.

The present invention relates to a photocurable molding resin composition containing a photopolymerizable substance (A) having a (meth)acryloyl group in the molecule thereof; a hydrogen abstraction type photopolymerization initiator (B); an intramolecular cleavage type photopolymerization initiator (C); and a silicone compound (D). The proportion of the silicone compound (D) is 1.0 to 5.0 parts by mass to the total mass of the composition that is 100 parts by mass of the constituents (A) to (C).

The present invention further relates to a molded multilayer article produced by shaping the composition so as to firmly adhere to a transparent resin substrate, and curing the composition.

### Advantageous Effects of Invention

According to the present invention, there can be provided a photocurable molding resin composition that exhibits a high adhesion to a variety of transparent resin substrates when formed into a resin layer on the transparent resin substrate, and a molded multilayer article having high adhesion between the resin layer and the transparent substrate.

### DESCRIPTION OF EMBODIMENTS

Examples of the photopolymerizable substance (A) used in the present invention, having a (meth)acryloyl group in the molecule thereof include di(meth)acrylates having a fluorene skeleton, acrylic (meth)acrylates, urethane (meth)acrylates, (meth)acrylic monomers, epoxy (meth)acrylates, acrylate compounds having a polyoxyalkylene structure, and other acryloyl group-containing organic monomer compounds.

An example of the di(meth)acrylate having a fluorene skeleton may be a compound expressed by the following structural formula (1):

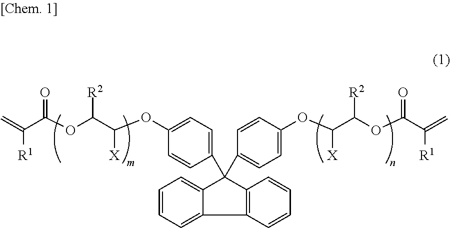

(In the formula, R₁ represents a hydrogen atom or a methyl group, R²'s each represent a hydrogen atom or a linear or branched alkyl group having 1 to 4 carbon atoms, and X's each represent a hydrogen atom or a hydroxy group. m and n each represent a numeral of 0 to 5.) Preferably, R² is a hydrogen atom or a methyl group from the viewpoint of imparting an appropriate refractive index to the cured product.

Preferably, m and n of general formula (1) are each in the range of 1 to 3 from the viewpoint of increasing the refractive index. More preferably, the sum of m and n is in the range of 0 to 4, and, in addition, the average thereof is 2 to 4.

Among the compounds expressed by general formula (1), preferred are the compound expressed by the following formula (1-1):

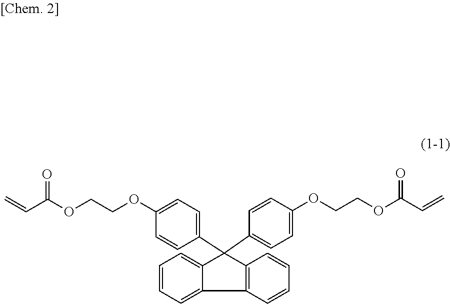

and the compound expressed by formula (1-2):

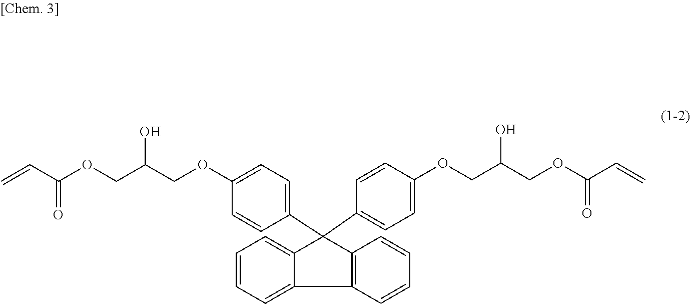 [SMILES: C=CC(=O)OCC(O)COc1ccc(C2(c3ccc(OCC(O)COC(=O)C=C)cc3)c3ccccc3-c3ccccc32)cc1]

These compounds are advantageous for increasing the refractive index of the cured product.

The acrylic (meth)acrylate may be, for example, a polymer produced by a reaction of a (meth)acrylic polymer (a1) having an epoxy group with a monomer (b) having an unsaturated double bond and a carboxyl group (this polymer is hereinafter abbreviated to “acrylic (meth)acrylate (A1)”) or a polymer produced by a reaction of a (meth)acrylic polymer (a2) having a carboxyl group with a monomer (c) having an unsaturated double bond and an epoxy group (this polymer is hereinafter abbreviated to “acrylic (meth)acrylate (A2)”).

The (meth)acrylic polymer (a1) having an epoxy group used for preparing acrylic (meth)acrylate (A1) may be produced by, for example, a copolymerization of a polymerizable monomer having an unsaturated double bond and an epoxy group with another polymerizable monomer selected as required.

Examples of the polymerizable monomer having an unsaturated double bond and an epoxy group include glycidyl (meth)acrylate, glycidyl α-ethyl(meth)acrylate, glycidyl α-n-propyl(meth)acrylate, glycidyl α-n-butyl(meth)acrylate, 3,4-epoxybutyl (meth)acrylate, 4,5-epoxypentyl (meth)acrylate, 6,7-epoxypentyl (meth)acrylate, 6,7-epoxypentyl α-ethyl(meth)acrylate, β-methylglycidyl (meth)acrylate, 3,4-epoxycyclohexyl (meth)acrylate, lactone-modified 3,4-epoxycyclohexyl (meth)acrylate, and vinyl cyclohexene oxide. These may be used singly or in combination.

Examples of the polymerizable monomer that can be copolymerized with the polymerizable monomer having an unsaturated double bond and an epoxy group include (meth)acrylic esters containing an alkyl group having a carbon number of 1 to 22, such as methyl (meth)acrylate, ethyl (meth)acrylate, propyl (meth)acrylate, butyl (meth)acrylate, hexyl (meth)acrylate, heptyl (meth)acrylate, octyl (meth)acrylate, nonyl (meth)acrylate, decyl (meth)acrylate, dodecyl (meth)acrylate, tetradecyl (meth)acrylate, hexadecyl (meth)acrylate, stearyl (meth)acrylate, octadecyl (meth)acrylate, and docosyl (meth)acrylate; (meth)acrylic esters containing an alicyclic alkyl group, such as cyclohexyl (meth)acrylate, isoboronyl (meth)acrylate, dicyclopentanyl (meth)acrylate, and dicyclopentenyloxyethyl (meth)acrylate; (meth)acrylic esters having an aromatic ring, such as benzoyloxyethyl (meth)acrylate, benzyl (meth)acrylate, phenylethyl (meth)acrylate, phenoxyethyl (meth)acrylate, phenoxydiethylene glycol (meth)acrylate, and 2-hydroxy-3-phenoxypropyl (meth)acrylate; hydroxyethyl (meth)acrylate; hydroxypropyl (meth)acrylate and glycerol (meth)acrylate; acrylic esters having a hydroxyalkyl group, such as lactone-modified hydroxyethyl (meth)acrylate, polyethylene glycol (meth)acrylate, polypropylene glycol (meth)acrylate, and other (meth)acrylic esters having a polyalkylene glycol group;

unsaturated dicarboxylic acid esters, such as dimethyl fumarate, diethyl fumarate, dibutyl fumarate, dimethyl itaconate, dibutyl itaconate, methylethyl fumarate, methylbutyl fumarate, and methylethyl itaconate; styrene and styrene derivatives, such α-methylstyrene and chlorostyrene; vinyl esters, such as vinyl acetate and vinyl butyrate; vinyl ethers, such as methyl vinyl ether and butyl vinyl ether; vinyl cyanides, such as acrylonitrile, methacrylonitrile, and vinylidene cyanide; and acrylamide and alkyd-substituted amides thereof. Among these, methyl (meth)acrylate is preferred from the viewpoint of imparting to the resulting cured acrylic (meth)acrylate an appropriate adhesion to polymethyl methacrylate that can be a non-adhesive substrate while maintaining the hardness of the cured acrylic (meth)acrylate.

For the raw materials of the reaction for (meth)acrylic polymer (a1) having an epoxy group, the mass ratio [polymerizable monomer having a double bond and an epoxy group]/[the other monomer] of the polymerizable monomer having a double bond and an epoxy group to the other polymerizable monomer is preferably in the range of 30/70 to 90/10 from the viewpoint of curability.

The epoxy equivalent weight of acrylic polymer (a1) having an epoxy group is preferably 140 to 500 g/eq, more preferably 140 to 400 g/eq, from the viewpoint of difficulty of gelation in the subsequent acrylic acid addition reaction. In the present invention, the epoxy equivalent weight is the value defined in JIS-K-7236.

Examples of monomer (b) having an unsaturated double bond and an epoxy group, which is one of the raw materials of the reaction for producing the acrylic (meth)acrylate (A1), include (meth)acrylic acid; unsaturated monocarboxylic acids having an ester bond, such as β-carboxyethyl (meth)acrylate, 2-acryloyloxyethylsuccinic acid, 2-acryloyloxyethylphthalic acid, 2-acryloyloxyethylhexahydrophthalic acid, and lactone-modified products thereof; and maleic acid. These may be used singly or in combination.

The reaction of (meth)acrylic polymer (a1) having an epoxy group with monomer (b) having an unsaturated double bond and a carboxyl group can be performed by uniformly mixing both materials and heating the mixture to a temperature of 80 to 120° C. The proportions of acrylic polymer (a1) having an epoxy group and monomer (b) having an unsaturated double bond and a carboxyl group are preferably such that the amount by mole of the carboxyl group in monomer (b) having an unsaturated double bond and a carboxyl group is 0.9 to 1.1 mol relative to 1 mol of the epoxy group in acrylic polymer (a1) having an epoxy group.

(Meth)acrylic polymer (a2) having a carboxyl group used for preparing the acrylic (meth)acrylate (A2) may be produced by, for example, a copolymerization of a polymerizable monomer having an unsaturated double bond and a carboxyl group with another polymerizable monomer.

Examples of the polymerizable monomer having an unsaturated double bond and a carboxyl group include (meth)acrylic acid; unsaturated monocarboxylic acids having an ester bond, such as β-carboxyethyl (meth)acrylate, 2-acryloyloxyethylsuccinic acid, 2-acryloyloxyethylphthalic acid, 2-acryloyloxyethylhexahydrophthalic acid, and lactone-modified products thereof; and maleic acid. Among these, (meth)acrylic acid is preferred from the viewpoint of imparting an appropriate hardness to the resulting cured acrylic (meth)acrylate.

The other of the polymerizable monomers used for preparing (meth)acrylic polymer (a2) having a carboxyl group may be selected from the polymerizable monomers cited as the other of the polymerizable monomers used for preparing (meth)acrylic polymer (a1).

For the raw materials of the reaction for (meth)acrylic polymer (a2) having a carboxyl group, the mass ratio [polymerizable monomer having a double bond and a carboxyl group]/[the other monomer] of the polymerizable monomer having a double bond and a carboxyl group to the other polymerizable monomer is preferably in the range of 30/70 to 90/10 from the viewpoint of curability.

(Meth)acrylic polymer (a2) having a carboxyl group can be produced under the same conditions as (meth)acrylic polymer (a1) having an epoxy group.

Examples of monomer (c) having an unsaturated double bond and an epoxy group, which is one of the raw materials of the reaction for producing the acrylic (meth)acrylate (A2), include glycidyl (meth)acrylate, glycidyl α-ethyl(meth)acrylate, glycidyl α-n-propyl(meth)acrylate, glycidyl α-n-butyl(meth)acrylate, 3,4-epoxybutyl (meth)acrylate, 4,5-epoxypentyl (meth)acrylate, 6,7-epoxypentyl (meth)acrylate, 6,7-epoxypentyl α-ethyl(meth)acrylate, β-methylglycidyl (meth)acrylate, 3,4-epoxycyclohexyl (meth)acrylate, lactone-modified 3,4-epoxycyclohexyl (meth)acrylate, and vinyl cyclohexene oxide. These may be used singly or in combination.

The acrylic (meth)acrylate (A2) can be produced under the same conditions as the acrylic (meth)acrylate (A1). The proportions of acrylic polymer (a2) having a carboxyl group and monomer (c) having an unsaturated double bond and an epoxy group are preferably such that the amount by mole of the epoxy group in monomer (c) having an unsaturated double bond and an epoxy group is 0.9 to 1.1 mol relative to 1 mol of the carboxyl group in acrylic polymer (a2) having a carboxyl group.

Preferably, the thus produced acrylic (meth)acrylate has a (meth)acryloyl equivalent weight in the range of 150 to 600 g/eq from the viewpoint of preventing gelation, and has a weight average molecular weight in the range of 10,000 to 100,000 from the viewpoint of increasing the adhesion to a variety of transparent resin substrates.

The weight average molecular weight (Mw) is the value measured by gel permeation chromatography (GPC) under the following conditions.

Measuring instrument: HLC-8220 GPC manufactured by Tosoh Corporation

Column: TSK-GUARD COLUMN Super HZ-L manufactured by Tosoh Corporation+TSK-GEL Super HZM-Mx4 manufactured by Tosoh Corporation

Detector: RI (differential refractometer)

Data processing: Multistation GPC-8020 model II produced by Tosoh Corporation

Measuring conditions: Column temperature 40° C.
Solvent tetrahydrofuran
Flow rate 0.35 mL/min

Reference: monodisperse polystyrene

Sample: Resin solution in tetrahydrofuran with a solid content of 0.2% by mass filtered through a microfilter (100 μL)

The epoxy (meth)acrylate may be a product of a reaction of an epoxy resin with (meth)acrylic acid or the anhydride thereof.

Examples of the epoxy resin that can be reacted with (meth)acrylic acid or the anhydride thereof include: diglycidyl ethers of dihydric phenols, such as hydroquinone and catechol; diglycidyl ethers of biphenol compounds, such as 3,3′-biphenyldiol and 4,4′-biphenyldiol; bisphenol epoxy resins, such as bisphenol A epoxy resin, bisphenol B epoxy resin, bisphenol F epoxy resin, and bisphenol S epoxy resin; polyglycidyl ethers of naphthol compounds, such as 1,4-naphthalene diol, 1,5-naphthalene diol, 1,6-naphthalene diol, 2,6-naphthalene diol, 2,7-naphthalene diol, binaphthol, bis(2,7-dihydroxynaphthyl)methane; triglycidyl ethers, such as 4,4′,4″-methylidyne trisphenol; phenol novolak epoxy resins, cresol novolak resins and other novolak epoxy resins;

polyglycidyl ethers of polyether-modified aromatic polyols produced by ring-opening polymerization of any one of the above-cited biphenol compounds, bisphenol A, bisphenol B, bisphenol F, bisphenol S and naphthol compounds with a cyclic ether compound, such as ethylene oxide, propylene oxide, tetrahydrofuran, ethyl glycidyl ether, propyl glycidyl ether, butyl glycidyl ether, phenyl glycidyl ether, or allyl glycidyl ether; and

polyglycidyl ethers of lactone-modified aromatic polyols produced by polycondensation of any one of the above-cited biphenol compounds, bisphenol A, bisphenol B, bisphenol F, bisphenol S and naphthol compounds with a lactone compound such as ε-caprolactone.

Among these, preferred are compounds having an aromatic ring skeleton in the molecule thereof, from the viewpoint of increasing the refractive index of the resulting cured epoxy (meth)acrylate. In particular, bisphenol-type epoxy resins and polyglycidyl ethers of naphthol compounds, particularly bisphenol-type epoxy resins, are advantageous for producing a cured article having a high refractive index and exhibiting a high adhesion to plastic film substrates even under high temperature, high humidity conditions.

Among bisphenol-type epoxy resins, preferred are those having an epoxy equivalent weight in the range of 160 to 1,000 g/eq, more preferably, in the range of 165 to 600 g/eq, from the viewpoint of producing a cured product have a high refractive index and a high hardness.

The (meth)acrylic acid or anhydride thereof to be subjected to reaction with the epoxy resin is preferably acrylic acid particularly from the viewpoint of producing a photocurable resin composition having good curability.

Preferably, the epoxy (meth)acrylate itself has a refractive index of 1.50 or more at 25° C.

The thus produced epoxy (meth)acrylate preferably has a weight average molecular weight (Mw) in the range of 350 to 5,000, more preferably in the range of 500 to 4,000, from the viewpoint of preparing a composition having a low viscosity and producing a cured product exhibiting high adhesion to plastic film substrates over a long time and having high adhesion to the substrates even under high temperature, high humidity conditions.

Preferably, the epoxy (meth)acrylate itself has a refractive index of 1.50 or more at 25° C. from the viewpoint of increasing the refractive index of the cure product.

In the present invention, the weight average molecular weight (Mw) is the value measured by gel permeation chromatography (GPC) under the following conditions.

Measuring instrument: HLC-8220 GPC manufactured by Tosoh Corporation

Column: TSK-GUARD COLUMN Super HZ-L manufactured by Tosoh Corporation+TSK-GEL Super HZM-Mx4 manufactured by Tosoh Corporation

Detector: RI (differential refractometer)

Data processing: Multistation GPC-8020 model II produced by Tosoh Corporation

Measuring conditions: Column temperature 40° C.
Solvent tetrahydrofuran
Flow rate 0.35 mL/min

Standard: monodisperse polystyrene

Sample: Resin solution in tetrahydrofuran with a solid content of 0.2% by mass filtered through a microfilter (100 μL)

The urethane (meth)acrylate may be a urethane (meth)acrylate (U1) produced by a reaction of a polyisocyanate compound (u1) with a (meth)acrylate compound (u2) having one hydroxy group in the molecule thereof, or a urethane (meth)acrylate (U2) produced by a reaction of a polyisocyanate compound (u3), a (meth)acrylate compound (u2) having one hydroxy group in the molecule thereof and a polyol compound (u4).

The polyisocyanate compound (u1) used as one of the raw materials of the urethane (meth)acrylate (U1) may be a diisocyanate monomer or an isocyanurate-type polyisocyanate compound having an isocyanurate ring structure in the molecule thereof.

Examples of the diisocyanate monomer include aliphatic diisocyanates, such as butane-1,4-diisocyanate, hexamethylene diisocyanate, 2,2,4-trimethylhexamethylene diisocyanate, and 2,4,4-trimethylhexamethylene diisocyanate;

alicyclic diisocyanates, such as cyclohexane-1,4-diisocyanate, isophorone diisocyanate, lysine diisocyanate, dicyclohexylmethane-4,4′-diisocyanate, 1,3-bis(isocyanatemethyl)cyclohexane, and methylcyclohexane diisocyanate; and

aromatic diisocyanates, such as 1,5-naphthylene diisocyanate, 4,4′-diphenylmethane diisocyanate, 2,2′-bis(p-phenylisocyanate)propane, 4,4′-dibenzyl diisocyanate, dialkyldiphenylmethane diisocyanate, tetraalkyldiphenylmethane diisocyanate, 1,3-phenylene diisocyanate, 1,4-phenylene diisocyanate, tolylene diisocyanate, xylylene diisocyanate, and m-tetramethylxylylene diisocyanate.

The isocyanurate-type polyisocyanate compound having an isocyanurate ring structure in the molecule thereof may be an isocyanurate-type polyisocyanate produced solely from the above-described diisocyanate monomer, or a urethane prepolymer having a terminal isocyanate group having an isocyanurate structure produced by a reaction of the diisocyanate monomer with a low-molecular-weight glycol. Furthermore, these isocyanurate-type polyisocyanates may be modified with a low-molecular-weight monoalcohol, from the viewpoint of controlling viscosity and preventing gelation.

The low-molecular-weight glycol is preferably a low-molecular-weight aliphatic/alicyclic glycol, and examples thereof include aliphatic diols, such as ethylene glycol (EG), 1,2-propanediol, 1,3-propanediol, 1,3-butanediol, 1,4-butanediol, 1,5-pentanediol, 1,6-hexanediol, neopentyl glycol, diethylene glycol, triethylene glycol, tetraethylene glycol, dipropylene glycol, tripropylene glycol, 3-methyl-1,5-pentanediol, 2-butyl-2-ethyl-1,3-propanediol, and 2-methyl-1,3-propanediol; alicyclic diols, such as 1,4-cyclohexanediol, 1,4-cyclohexanedimethanol, and hydrogenated bisphenol A; and hydroxy group-containing tri- or more functional organic compounds, such as glycerin, trimethylolpropane, and pentaerythritol. The glycol may have a linear chain structure, a branched chain structure or a cyclic structure. These may be used singly or in combination.

The low-molecular-weight monoalcohol is preferably a linear or branched alcohol having a carbon number of 1 to 9, or an alicyclic alcohol, and examples thereof include methanol, ethanol, n-propanol, isopropanol, n-butanol, isobutanol, sec-butanol, n-pentanol, n-hexanol, n-octanol, n-nonanol, 2-ethylbutanol, 2,2-dimethylhexanol, 2-ethylhexanol, cyclohexanol, methylcyclohexanol, and ethylcyclohexanol. These may be used singly or in combination.

Examples of the (meth)acrylate compound (u2) having a hydroxy group in the molecule thereof, used as one of the raw materials of the urethane (meth)acrylate (U1) include aliphatic (meth)acrylate compounds, such as 2-hydroxyethyl acrylate, 2-hydroxypropyl acrylate, 4-hydroxybutyl acrylate, glycerin diacrylate, trimethylolpropane diacrylate, pentaerythritol triacrylate, and dipentaerythritol pentaacrylate; and

(meth)acrylate compounds having an aromatic ring in the molecule thereof, such as 4-hydroxyphenyl acrylate, β-hydroxyphenethyl acrylate, 4-hydroxyphenethyl acrylate, 1 phenyl-2-hydroxyethyl acrylate, 3-hydroxy-4-acetylphenyl acrylate, and 2-hydroxy-3-phenoxypropyl acrylate. These may be used singly or in combination.

Among the urethane (meth)acrylates (U1), preferred are urethane (meth)acrylates produced by a reaction of an aromatic diisocyanates with an aliphatic (meth)acrylate compound, and urethane (meth)acrylate compounds produced by a reaction of an aliphatic or alicyclic diisocyanate with a (meth)acrylate compound having an aromatic ring in the molecule thereof. The use of these urethane (meth)acrylates provides a resin composition having a low viscosity and a high refractive index.

Furthermore, from the viewpoint of producing a molded article having higher toughness, particularly preferred are urethane (meth)acrylates produced by a reaction of tolylene diisocyanate with an aliphatic (meth)acrylate compound having one (meth)acryloyl group in the molecule thereof, such as 2-hydroxyethyl acrylate, 2-hydroxypropyl acrylate, or 4-hydroxybutyl acrylate, and the urethane (meth)acrylate produced by a reaction of isophorone diisocyanate with 2-hydroxy-3-phenoxypropyl acrylate.

The production of the urethane (meth)acrylate (U1) may be performed, for example, at a temperature in the range of 20 to 120° C., using the polyisocyanate compound (u1) and the (meth)acrylate compound (u2) having one hydroxy group in the molecule thereof in a proportion in which the mole ratio [(NCO)/(OH)] of the isocyanate group of the polyisocyanate compound (u1) to the hydroxy group of the (meth)acrylate compound (x2) having on hydroxy group in the molecule thereof is in the range of 1/0.95 to 1/1.05. A known urethanation catalyst may be used as required.

The polyisocyanate compound (u3) used as one of the raw materials of the urethane (meth)acrylate (U2) may be any one of the polyisocyanate compounds (u1) cited as a raw material of the urethane (meth)acrylate (U1), or an adduct-type polyisocyanate compound having a urethane binding site in the molecule thereof, produced by a reaction of the polyisocyanate compound (u1) with a polyol.

Examples of the polyol used as one of the raw materials of the adduct-type polyisocyanate compound include ethylene glycol, diethylene glycol, propylene glycol, 1,3-propanediol, 1,4-butanediol, 1,3-butanediol, 3-methyl-1,3-butanediol, 1,5-pentanediol, neopentyl glycol, 1,6-hexanediol, trimethylolethane, trimethylolpropane, and glycerin. These may be used singly or in combination.

Preferably, the polyisocyanate compound (u3) is a diisocyanate monomer from the viewpoint of preparing a resin composition that has a low viscosity and results in a cured product having a high refractive index.

Examples of the polyol compound (u4) used as one of the raw materials of the urethane (meth)acrylate (U2) include aliphatic polyols, such as ethylene glycol, diethylene glycol, propylene glycol, 1,3-propanediol, 1,4-butanediol, 1,3-butanediol, 3-methyl-1,3-butanediol, 1,5-pentanediol, neopentyl glycol, 1,6-hexanediol, trimethylolethane, trimethylolpropane, and glycerin;

aromatic polyols, such as hydroquinone, catechol, 1,4-benzenedimethanol, 3,3′-biphenyldiol, 4,4′-biphenyldiol, biphenyl-3,3′-dimethanol, biphenyl-4,4′-dimethanol, bisphenol A, bisphenol B, bisphenol F, bisphenol S, 1,4-dihydroxynaphthalene, 1,6-dihydroxynaphthalene, 2,7-naphthalenediol, binaphthol, bis(2,7-dihydroxynaphthyl)methane, and 4,4′,4″-methylidynetrisphenol;

polyether-modified aromatic polyols produced by ring-opening polymerization of any one of the above-cited aromatic polyols and a cyclic ether compound, such as ethylene oxide, propylene oxide, tetrahydrofuran, ethyl glycidyl ether, propyl glycidyl ether, butyl glycidyl ether, phenyl glycidyl ether, or allyl glycidyl ether;

lactone-modified aromatic polyols produced by polycondensation of any one of the above-cited aromatic polyols and a lactone compound, such as ε-caprolactone;

aromatic ring-containing polyester polyols produced by a reaction of an aliphatic dicarboxylic acid, such as malonic acid, succinic acid, glutaric acid, adipic acid, or pimelic acid, with any one of the above-cited aromatic polyols; and

aromatic ring-containing polyester polyols produced by a reaction of an aromatic dicarboxylic acid or the anhydride thereof, such as phthalic acid, phthalic anhydride, terephthalic acid, isophthalic acid, or o-phthalic acid, with any one of the above-cited aliphatic polyols; These may be used singly or in combination. Among these polyol compounds, preferred are bisphenol compounds, such as bisphenol A, bisphenol B, bisphenol S, and bisphenol F, and polyether-modified bisphenol compounds produced by ring-opening polymerization of any of those bisphenol compounds and a cyclic ether compound, from the viewpoint of producing a cured product having a high refractive index and a high toughness.

The production of the urethane (meth)acrylate (U2) may be performed, for example, by producing a reaction intermediate at a temperature in the range of 20 to 120° C., using the polyol compound (u4) and the polyisocyanate compound (u3) in a proportion in which the mole ratio [(OH)/(NCO)] of the hydroxy group of the polyol compound (u4) to the isocyanate group of the polyisocyanate compound (u3) is in the range of 1/1.5 to 1/2.5, optionally with a known urethanation catalyst, and then reacting the intermediate with the (meth)acrylate compound (u2) having one hydroxyl group in the molecule thereof optionally with a known urethane catalyst at a temperature in the range of 20 to 120° C. in a proportion in which the mole ratio [(OH)/(NCO)] of the hydroxy group of the (meth)acrylate compound (u2) having one hydroxy group in the molecule thereof to the isocyanate group of the intermediate is in the range of 1/0.95 to 1/1.05.

Alternatively, the urethane (meth)acrylate (U2) may be produced, for example, by reacting the polyol compound (u4), the polyisocyanate compound (u3) and the (meth)acrylate compound (u2) having one hydroxy group in the molecule thereof at one time, or reacting the polyisocyanate compound (u3) with the (meth)acrylate compound (u2) having one hydroxy group in the molecule thereof, followed by reaction with the polyol compound (u4).

Among those urethane (meth)acrylates, urethane (meth)acrylate (U2) is suitable for producing a cured product having a high refractive index and a high toughness. In particular, preferred is a urethane (meth)acrylate having a bis(phenylene)alkane skeleton in the molecule thereof, produced by a reaction of diisocyanate, an aliphatic mono(meth)acrylate, a bisphenol compound and a polyether-modified bisphenol compound.

The thus produced urethane (meth)acrylate preferably has a weight average molecular weight (Mw) in the range of 350 to 5,000, more preferably in the range of 400 to 3,500, from the viewpoint of preparing a composition having a low viscosity and producing a cured product exhibiting a satisfactory toughness.

In the present invention, the weight average molecular weight (Mw) is the value measured by gel permeation chromatography (GPC) under the following conditions.

Measuring instrument: HLC-8220 GPC manufactured by Tosoh Corporation

Column: TSK-GUARD COLUMN Super HZ-L manufactured by Tosoh Corporation
+TSK-GEL Super HZM-Mx4 manufactured by Tosoh Corporation

Detector: RI (differential refractometer)

Data processing: Multistation GPC-8020 model II produced by Tosoh Corporation

Measuring conditions: Column temperature 40° C.
Solvent tetrahydrofuran
Flow rate 0.35 mL/min

Reference: monodisperse polystyrene

Sample: Resin solution in tetrahydrofuran with a solid content of 0.2% by mass filtered through a microfilter (100 μL)

Preferably, the urethane (meth)acrylate itself has a refractive index of 1.50 or more at 25° C.

Other acryloyl group-containing organic compound monomers include monofunctional (meth)acrylate compounds, bifunctional aliphatic (meth)acrylate compounds, and tri- or more functional aliphatic (meth)acrylates. Exemplary monofunctional (meth)acrylate compounds include high-refractive-index monofunctional (meth)acrylate compounds, such as phenylbenzyl (meth)acrylate (PBA), phenylthioethyl(meth)acrylate (PTEA), o-phenylphenoxyethyl (meth)acrylate (OPPEA), and naphthylthioethyl (meth)acrylate (NTEA); and other monofunctional (meth)acrylate compounds, such as n-butyl (meth)acrylate, isobutyl (meth)acrylate, tert-butyl (meth)acrylate, n-pentyl (meth)acrylate, n-hexyl (meth)acrylate, n-octyl (meth)acrylate, isooctyl (meth)acrylate, 2-ethylhexyl (meth)acrylate, benzyl (meth)acrylate, glycidyl (meth)acrylate, morpholine (meth)acrylate, 2-hydroxy ethyl (meth)acrylate, 2-hydroxypropyl (meth)acrylate, 4-hydroxybutyl (meth)acrylate, diethylene glycol mono(meth)acrylate, triethylene glycol mono(meth)acrylate, dipropylene glycol mono(meth)acrylate, 2-methoxyethyl (meth)acrylate, methoxydiethylene glycol (meth)acrylate, methoxytriethylene glycol (meth)acrylate, methoxypolyethylene glycol (meth)acrylate, 2-butoxyethyl (meth)acrylate, butoxytriethylene glycol (meth)acrylate, 2-ethoxyethyl (meth)acrylate, 2-(2-ethoxyethoxyl)ethyl (meth)acrylate, ethoxypolyethylene glycol (meth)acrylate, 4-nonylphenoxyethylene glycol (meth)acrylate, tetrahydrofurfuryl (meth)acrylate, caprolactone-modified tetrahydrofurfuryl (meth)acrylate, cyclohexyl (meth)acrylate, isobornyl (meth)acrylate, 2-hydroxy-3-phenoxy propyl (meth)acrylate, cyclohexyl (meth)acrylate, cyclohexylmethyl (meth)acrylate, cyclohexylethyl (meth)acrylate, dicyclo pentanyl (meth)acrylate, dicyclopentanyloxyethyl (meth)acrylate, dicyclopentenyl (meth)acrylate, dicyclopentenyloxyethyl (meth)acrylate, phenoxyethyl (meth)acrylate, and phenoxydiethylene glycol (meth)acrylate.

Exemplary bifunctional aliphatic (meth)acrylate compounds include ethylene glycol di(meth)acrylate, diethylene glycol di(meth)acrylate, triethylene glycol di(meth)acrylate, polyethylene glycol di(meth)acrylate, propylene glycol di(meth)acrylate, dipropylene glycol di(meth)acrylate, tripropylene glycol di(meth)acrylate, butylene glycol di(meth)acrylate, tetrabutylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dicyclopentanyl di(meth)acrylate, glycerol di(meth)acrylate, neopentyl glycol hydroxypivalic acid ester di(meth)acrylate, caprolactone-modified hydroxypivalic acid neopentyl glycol di(meth)acrylate, hydroxypival aldehyde-modified trimethylolpropane di(meth)acrylate, and 1,4-cyclohexanedimethanol di(meth)acrylate.

Tri- or more functional aliphatic (meth)acrylate compounds include trimethylolpropane tri(meth)acrylate, trimethylolpropane ethylene oxide adduct tri(meth)acrylate, trimethylolpropane propylene oxide adduct tri(meth)acrylate, pentaerythritol tri(meth)acrylate, glycerol tri(meth)acrylate, alkyl-modified dipentaerythritol tri(meth)acrylate, ditrimethylolpropane tetra(meth)acrylate, ditrimethylolpropane ethylene oxide adduct tetra(meth)acrylate, ditrimethylolpropane propylene oxide adduct tetra(meth)acrylate, dipentaerythritol penta(meth)acrylate, and dipentaerythritol hexa(meth)acrylate.

Preferably, the photopolymerizable substance (A) used in the present invention, having a (meth)acryloyl group in the molecule thereof is used in part with an acrylate compound having a polyoxyalkylene structure, in addition to the above-described constituents, from the viewpoint of imparting appropriate flexibility to the cured product, and particularly increasing the shape recovery of the cured product when used as a prism lens.

The photopolymerizable substance (A) used herein having a (meth)acryloyl group has a polyoxyalkylene structure, such as a polyethylene glycol chain or a polypropylene glycol chain, in the molecule thereof, and examples thereof include diacrylates of polyethylene glycols having 4 to 15 ethylene oxide units, monoacrylates of polyethylene glycols having 4 to 15 ethylene oxide units, diacrylates of polypropylene glycols having 4 to 15 propylene oxide units, monoacrylates of polypropylene glycols having 4 to 15 propylene oxide units, ethylene oxide-modified glycerol triacrylate (3 to 10 EO units), propylene oxide-modified glycerol triacrylate (3 to 10 PO units), ethylene oxide-modified trimethylolpropane triacrylate (4 to 20 EO units), propylene oxide-modified trimethylolpropane triacrylate (4 to 20 PO units), diacrylates of bisphenol ethylene oxide adduct having 4 to 15 ethylene oxide units, and diacrylates of bisphenol propylene oxide adduct having 4 to 15 propylene oxide units.

Among these preferred are diacrylates of polyethylene glycols having 4 to 15 ethylene oxide units, ethylene oxide-modified trimethylolpropane triacrylate (4 to 20 EO units), propylene oxide-modified trimethylolpropane triacrylates (4 to 20 PO units), diacrylates of bisphenol ethylene oxide-adducts having 4 to 15 ethylene oxide units, and diacrylates of bisphenol propylene oxide-adducts having 4 to 15 propylene oxide units. These compounds can reduce the glass transition temperature of the cured article and improve the shape recovery thereof. Particularly preferred are diacrylates of bisphenol ethylene oxide adducts having 4 to 30 ethylene oxide units and diacrylates of bisphenol propylene oxide adducts having 4 to 15 propylene oxide units, from the viewpoint of reducing the glass transition temperature and having good compatibility with other photopolymerizable substances (A). In particular, the former diacrylates, which are those of bisphenol ethylene oxide adducts having 4 to 30 ethylene oxide units, are advantageous and superior in terms of shape recovery.

Examples of the diacrylates of bisphenol ethylene oxide adducts having 4 to 30 ethylene oxide units include bisphenol A ethylene oxide adduct di(meth)acrylate and bisphenol F ethylene oxide adduct di(meth)acrylate.

Among the above-described photopolymerizable substances (A) having a (meth)acryloyl group in the molecule thereof, preferred are di(meth)acrylates having a fluorene skeleton, acrylic (meth)acrylates, urethane (meth)acrylates, and other acryloyl group-containing organic monomer compounds, from the viewpoint of increasing the refractive index of prism lenses when used therein. It is more preferable to use such a photopolymerizable substance in combination, in part, with an acrylate compound having a polyoxyalkylene structure. This enables the resulting cured product to have appropriate flexibility and exhibit markedly improved shape recovery.

In this instance, the proportion of the acrylate compound having a polyoxyalkylene structure is preferably such that the content thereof is 30% to 100% by mass in the photopolymerizable substance (A).

From the viewpoint of markedly improving shape recovery, the proportion of the acrylate compound having a polyoxyalkylene structure is preferably such that the content thereof is in the range of 5% to 30% by mass in the photopolymerizable substance (A) having a (meth)acryloyl group in the molecule thereof.

It is also advantageous for increasing the refractive index of the cured product that a high-refractive-index monofunctional (meth)acrylate compound is added to di(meth)acrylate having a fluorene skeleton, acrylic (meth)acrylate or urethane (meth)acrylate. Preferred high-refractive-index monofunctional (meth)acrylates are phenylbenzyl (meth)acrylate (PBA) and o-phenylphenoxyethyl (meth)acrylate (OPPEA). These are not colored much and have high refractive indices.

If the high-refractive-index monofunctional (meth)acrylate compound is added, the content thereof in the photopolymerizable substance (A) having a (meth)acryloyl group is preferably 40% to 80% by mass from the viewpoint of markedly increasing refractive index.

The hydrogen abstraction type photopolymerization initiator (B) used in the present invention may be benzophenone, benzyl, Michler's ketone, thioxanthone or anthraquinone. In the present invention, the hydrogen abstraction type photopolymerization initiator (B) is intended to dramatically increase the adhesion to the transparent resin substrate substantially without using a compound acting as a hydrogen donor, which is generally used with a hydrogen abstraction type photopolymerization initiator.

Examples of the intramolecular cleavage type photopolymerization initiator (C) include benzoin, dialkoxyacetophenone, acyl oxime ester, benzylketal, hydroxyalkylphenone, halogenoketone, and 2,4,6-trimethylbenzoyldiphenylphosphine oxide.

In particular, preferred is a combined use of 2,4,6-trimethylbenzoyldiphenylphosphine oxide or any other photopolymeriable initiator sensitive to light having wavelengths in the range of 380 nm to 600 nm, from the viewpoint of increasing curability.

The proportions of the hydrogen abstraction type photopolymerization initiator (B) and the intramolecular cleavage type photopolymerization initiator (C) are preferably 1.0 to 10 parts by mass and 0.5 to 10 parts by mass, respectively, relative to the total mass of the composition that is 100 parts by mass of the constituents (A) to (C), from the viewpoint of compatibility of curability with adhesion.

The silicone compound (D) used in the present invention may be unreactive silicone oil, unreactive silicone surfactant, or polymerizable silicone (meth)acrylate. Examples of the unreactive silicone oil include dimethyl silicone oil, methylphenyl silicone oil, and methylhydrogen silicone oil. The silicone surfactant may be a polyether-modified polydimethylsiloxane.

The silicone (meth)acrylate is preferably a compound having a siloxane bond having at least one group selected from among (meth)acryloyl and (meth)acryloyloxy groups at least either in the side chain or at the terminal of the molecule thereof, and having a weight average molecular weight (Mw) of 1000 to 100,000.

Examples of the silicone (meth)acrylate include polyol-modified polyorganosiloxane acrylates; polyfunctional (meth)acrylates produced by a reaction of a polyorganosiloxane with pentaerythritol di(meth)acrylate, pentaerythritol diacrylate monomethacrylate, pentaerythritol tri(meth)acrylate or pentaerythritol tetra(meth)acrylate.

Examples of the silicone (meth)acrylate that can be used in the present invention include dimethyl siloxanes having a polyether-modified acryloyl group: product names “BYK-UV 3530” and “BYK-UV 3500” produce by BYK; solution of polydimethyl siloxane having a polyester-modified acryloyl group: product name “BYK-UV 3570” produced by BYK; polydimethyl siloxanes having a polyether-modified acryloyl group: product names “TEGO Rad-2250”, “TEGO Rad-2300”, and “TEGO Rad-2600” produced by Evonik Industries; polydimethyl siloxanes having a polyether alkyl spacer-modified acryloyl group: product names “TEGO Rad-2100” and “TEGO Rad-2200N” produced by Evonik Industries; both-terminal silicone methacrylate: product name “X-62-7205” produced by Shin-Etsu Chemical; and siliconized urethane acrylate oligomer: product name “CN990” produced by Sartomer.

The proportion of the silicone compound (D) is 1.0 to 5.0 parts by mass relative to the total mass of the composition that is 100 parts by mass of the constituents (A) to (C). Such a proportion enables the hydrogen abstraction type photopolymerization initiator (B) to be unevenly distributed to the vicinity of the transparent resin substrate when the composition of the present invention has been brought into contact with the transparent resin substrate, and thus dramatically increases the adhesion to the transparent resin substrate when the composition has been photopolymerized.

The photocurable resin composition of the present invention may further contain other additives if necessary. Examples of the additives include an ultraviolet absorbent, an antioxidant, a silicone additive, a fluorine-based additive, a rheology controlling agent, a defoaming agent, an antistatic agent, and an antifog agent. The amount of these additives to be added is in a range in which the additives can fully produce the effects thereof without retarding UV curing, and is preferably in the range of 0.01 to 40 parts by mass relative to 100 parts by mass of the photocurable resin composition of the present invention. The photocurable resin composition of the present invention may also contain an organic solvent if necessary. The present invention however enables dramatic improvement of the adhesion to the transparent resin substrate substantially without using an organic solvent. This feature of the present invention is not presented by paint-type compositions containing an organic solvent, and is noteworthy.

The photocurable resin composition of the present invention preferably has a viscosity of 6,000 mPa·s or less from the viewpoint of delivering the active-energy-curable resin composition to the entirety of the mold, including narrow portions, even under high-speed application conditions.

The photocurable resin composition of the present invention can be cured by being irradiated with light rays from ultraviolet light to visible light.

For being cured with ultraviolet light, the composition may be irradiated using an ultrahigh-pressure mercury-vapor lamp, a high-pressure mercury-vapor lamp, a low-pressure mercury-vapor lamp, a xenon lamp, a carbon arc lamp, a metal halide lamp, or the like. The ultraviolet exposure among is preferably in the range of 0.1 to 1000 mJ/cm².

The molded multilayer article of the present invention is a cured product produced by shaping the photocurable resin composition so as to firmly adhere to a transparent resin substrate, and curing the composition. The cured product of the photocurable resin composition has a high refractive index and good adhesion to the substrate. Accordingly, the molded multilayer article of the present invention may be used for plastic lenses, such as eyeglass lenses, digital camera lenses, Fresnel lenses, and prism lenses, and molded optical materials, such as optical fiber, optical waveguides, holograms, TV light guide plates, and light diffusion sheets. The molded multilayer article is particularly suitable for plastic lenses such as prism lenses for liquid crystal substrates, TV light guide plates, and light diffusion sheets.

The prism lens for liquid crystal substrates is a sheet lens having a plurality of fine prim-shaped portions on one side thereof. In general, the prism lens is used in such a manner that the prism side thereof faces the rear side of the liquid crystal element (side closer to the light source) and that a light guide sheet is further disposed at the rear side of the prism lens, or, alternatively, the prism lens doubles as the function of the light guide sheet.

The prism portions of the prism lens have a shape preferably having an apex angle θ in the range of 70° to 110°, more preferably in the range of 75° to 100°, particularly preferably in the range of 80° to 95°, from the viewpoint of enhancing light collection and increasing luminance.

Also, the prisms are arranged preferably at a pitch of 100 μm or less, particularly preferably 70 μm or less, from the viewpoint of preventing the occurrence of a moire pattern on the display and increasing the definition of the display. The height between the recesses and the protrusions of the prisms, which depends on the apex angle θ of the prisms and the pitch of the prisms, is preferably 50 μm or less. Although it is advantageous that the portion including the prisms of the prism lens has a large thickness in view of strength, a small thickness is advantageous in view of optics for reducing light absorption. From the viewpoint of the balance of these points of view, the thickness of the prism portion is preferably in the range of the thickness of the prisms between the recesses and the protrusions, plus 5 to 20 μm.

For manufacturing the prism lens using the photocurable resin composition of the present invention, for example, a process may be applied which is performed by applying the composition to a metal or resin mold having a prism pattern, smoothing the surface of the composition, subsequently superposing a transparent substrate on the composition, and then irradiating the composition with an active energy radiation through the transparent resin substrate to cure the composition.

The transparent substrate may be a plastic substrate made of acrylic resin, polycarbonate resin, polyester resin, polystyrene resin, fluororesin or polyimide resin, or a glass substrate.

The prism sheet produced by the above-described process may be used as it is, or in the form of independent prism lenses separated from the transparent substrate. If the prism sheet is used in a form including the prism portions formed on the transparent substrate, it is preferable that the surface of the transparent substrate be subjected to treatment for increasing adhesion, such as primer treatment, in order to increase the adhesion between the prism lens and the transparent substrate.

If the prism sheet is use in a form separated from the transparent substrate, it is preferable that the transparent substrate be surface-treated with silicone or fluorine-containing release agent so as to be easily removed.

When the photocurable resin composition of the present invention is used in optical materials such as the above-described prism lens, the refractive index of the composition is preferably 1.550 or more, and more preferably 1.570 or more.

For manufacturing a light guide plate using the photocurable resin composition of the present invention, a process may be applied which is performed by preparing the composition optionally containing acrylic beads, silica beads, or metal oxide beads such as those of alumina, titania or zirconia, for increasing luminance, coating one or both of the surfaces of a transparent substrate of polyethylene terephthalate, polycarbonate, polymethyl methacrylate or the like having a thickness of about 100 to 10000 μm with the photocurable resin composition, subsequently shaping the composition in a transparent, flexible soft mold, and then irradiating the composition with active-energy radiation to cure the composition.

For manufacturing a light diffusion sheet using the photocurable resin composition of the present invention, a process may be applied which is performed by preparing the composition optionally containing a light diffusing agent, and applying the composition onto a transparent resin substrate by a known method, and curing the composition.

### EXAMPLES

The present invention will be specifically described using Examples and Comparative Examples, but is not limited to the Examples. In the description of the Examples, part(s) and % are all on a weight basis, except for light transmittance. The weight average molecular weight (Mw) of acrylic acrylate [(A)-3] was measured by gel permeation chromatography (GPC) under the following conditions.

Measuring instrument: HLC-8220 GPC manufactured by Tosoh Corporation

Column: TSK-GUARD COLUMN Super HZ-L manufactured by Tosoh Corporation+TSK-GEL Super HZM-Mx4 manufactured by Tosoh Corporation

Detector: RI (differential refractometer)

Data processing: Multistation GPC-8020 model II produced by Tosoh Corporation

Measuring conditions: Column temperature 40° C.
Solvent tetrahydrofuran
Flow rate 0.35 mL/min

Reference: monodisperse polystyrene

Sample: Resin solution in tetrahydrofuran with a solid content of 0.2% by mass filtered through a microfilter (100 μL)

### Examples 1 to 12 and Comparative Examples 1 to 5

Active energy-curable molding resin compositions were prepared according to the compositions shown in Tables 1 and 2.

Each of the resulting active-energy-curable molding resin composition was introduced between a textured mold having an linear arrangement of unit prisms (pitch: 50 μm, height: 25 μm) and the transparent resin substrate shown in Table 1 or 2, and was then cured by being irradiated with ultraviolet light of 800 mJ/cm2 from a ultrahigh-pressure mercury-vapor lamp through the transparent resin substrate. Subsequently, the transparent resin substrate with the active-energy-cured resin layer was separated from the mold to yield a cured resin sheet (L) having a pattern formed by transferring a required pattern (thickness of the active-energy-cured resin layer: 20 to 30 μm).

The resulting cured resin sheet (L) having a transferred pattern was subjected to measurements for adhesion and refractive index.

<Estimation of Adhesion>

The primary adhesion and secondary adhesion of the cured resin sheet (L) having a transferred pattern were estimated by the following method in accordance with JIS K-5400.

Primary adhesion: Immediately after the formation of the cured resin sheet (L) having a transferred pattern, cross-cut (100 squares) separation test was performed on the cured resin sheet, and the number of squares from which the sheet had been separated was counted.

Secondary adhesion: After the formation of the cured resin sheet (L) having a transferred pattern, the cured resin sheet was immersed in boiling water for 10 minutes, and then the above separation test was performed. The results

<Estimation of Refractive Index>

The refractive index mentioned in the present invention was measured with an Abbe refractometer (“NAR-3T” manufactured by Atago). For the measurement, the temperature was set normally at 25° C., and for samples that are solid at 25° C., an appropriate temperature was set.

TABLE 1

| | | | Example | Example | Example | Example | Example | Example | Example |
|---|---|---|---|---|---|---|---|---|---|
| | | | 1 | 2 | 3 | 4 | 5 | 6 | 7 |
| Photopolymerizable | (A)-1 | | 50 | | | | | | |
| substance (A) | (A)-2 | | | 20 | | | 20 | 20 | 20 |
| | (A)-3 | | | | | 20 | | | |
| | (A)-4 | | | 40 | 40 | 40 | 40 | 40 | 40 |
| | (A)-5 | | 50 | | | | | | |
| | (A)-6 | | | | 20 | | | | |
| | (A)-7 | | | 40 | 20 | 40 | 40 | 40 | 40 |
| Hydrogen | (B)-1 | | 4 | 4 | 4 | 4 | 4 | 4 | 4 |
| abstraction type | | | | | | | | | |
| photopolymerization | | | | | | | | | |
| initiator (B) | | | | | | | | | |
| Intramolecular | (C)-1 | | 3 | 1 | 1 | 1 | 1 | 1 | 1 |
| cleavage type | | | | | | | | | |
| photopolymerization | | | | | | | | | |
| initiator (C) | | | | | | | | | |
| Silicone compound | (D)-1 | | 1.5 | 1.5 | 1.5 | 1.5 | | | |
| (D) | (D)-2 | | | | | | 1.5 | | |
| | (D)-3 | | | | | | | 1.5 | |
| | (D)-4 | | | | | | | | 1.5 |
| Other additives | Polymethyl methacrylate | | | | 20 | | | | |
| | Triethylamine | | | | | | | | |
| Evaluation test | Primary | PET | 100/100 | 100/100 | 100/100 | 100/100 | 100/100 | 100/100 | 100/100 |
| result | adhesion | Polycarbonate | 100/100 | 100/100 | 100/100 | 100/100 | 100/100 | 100/100 | 100/100 |
| | | PMMA plate | 10/100 | 100/100 | 100/100 | 100/100 | 100/100 | 90/100 | 50/100 |
| | | ABS plate | 50/100 | 100/100 | 100/100 | 100/100 | 100/100 | 100/100 | 90/100 |
| | | MS plate | 10/100 | 100/100 | 100/100 | 100/100 | 100/100 | 100/100 | 80/100 |
| | Secondary | PET | 100/100 | 100/100 | 100/100 | 100/100 | 100/100 | 100/100 | 100/100 |
| | adhesion | Polycarbonate | 100/100 | 100/100 | 100/100 | 100/100 | 100/100 | 100/100 | 100/100 |
| | | PMMA plate | 0/100 | 100/100 | 100/100 | 100/100 | 100/100 | 50/100 | 0/100 |
| | | ABS plate | 0/100 | 100/100 | 100/100 | 100/100 | 100/100 | 100/100 | 20/100 |
| | | MS plate | 0/100 | 100/100 | 100/100 | 100/100 | 100/100 | 80/100 | 20/100 |

| | | | | | | | |
|---|---|---|---|---|---|---|---|
| Refractive index | 1.604 | 1.524 | 1.535 | 1.540 | 1.525 | 1.525 | 1.525 |

TABLE 2

| | | | | | | Compar- | Compar- | Compar- | Compar- | Compar- |
|---|---|---|---|---|---|---|---|---|---|---|
| | | | Example | Example | Example | ative | ative | ative | ative | ative |
| | | | 10 | 11 | 12 | Example 1 | Example 2 | Example 3 | Example 4 | Example 5 |
| Photopoly- | (A)-1 | | | | | | | | 50 | |
| merizable | (A)-2 | | 20 | 20 | 20 | 20 | 20 | 20 | | 20 |
| substance | (A)-4 | | 40 | 40 | 40 | 40 | 40 | 40 | | 40 |
| (A) | (A)-5 | | | | | | | | 50 | |
| | (A)-7 | | 40 | 40 | 40 | 40 | 40 | 40 | | 70 |
| Hydrogen | (B)-1 | | | | | 4 | 4 | | | |
| abstraction | (B)-2 | | 4 | | | | | | | 4 |
| type photopoly- | (B)-3 | | | 4 | | | | | | |
| merization | (B)-4 | | | | 4 | | | | | |
| initiator (B) | | | | | | | | | | |
| Intramolecular | (C)-1 | | 1 | 1 | 1 | 1 | 1 | 2 | 3 | 1 |
| cleavage type | | | | | | | | | | |
| photopoly- | | | | | | | | | | |
| merization | | | | | | | | | | |
| initiator (C) | | | | | | | | | | |
| Silicone | (D)-1 | | 1.5 | 1.5 | 1.5 | | | | | 0.1 |
| compound (D) | | | | | | | | | | |
| Other additives | Polymethyl methacrylate | | | | | | | | | |
| | Triethylamine | | | | | | 4 | | | |
| Evaluation | Primary | PET | 100/100 | 100/100 | 100/100 | 100/100 | 100/100 | 100/100 | 90/100 | 100/100 |
| test result | adhesion | Polycarbonate | 100/100 | 100/100 | 100/100 | 100/100 | 100/100 | 100/100 | 0/100 | 100/100 |
| | | PMMA plate | 100/100 | 100/100 | 100/100 | 0/100 | 0/100 | 0/100 | 0/100 | 0/100 |
| | | ABS plate | 100/100 | 100/100 | 100/100 | 50/100 | 70/100 | 0/100 | 0/100 | 40/100 |
| | | MS plate | 100/100 | 100/100 | 100/100 | 0/100 | 50/100 | 0/100 | 0/100 | 0/100 |
| | Secondary | PET | 100/100 | 100/100 | 100/100 | 100/100 | 100/100 | 100/100 | 0/100 | 100/100 |
| | adhesion | Polycarbonate | 100/100 | 100/100 | 100/100 | 100/100 | 100/100 | 100/100 | 0/100 | 100/100 |
| | | PMMA plate | 100/100 | 100/100 | 100/100 | 0/100 | 0/100 | 0/100 | 0/100 | 0/100 |
| | | ABS plate | 100/100 | 100/100 | 100/100 | 0/100 | 0/100 | 0/100 | 0/100 | 0/100 |
| | | MS plate | 100/100 | 100/100 | 100/100 | 0/100 | 0/100 | 0/100 | 0/100 | 0/100 |

| | | | | | | | | |
|---|---|---|---|---|---|---|---|---|
| Refractive index | 1.530 | 1.530 | 1.530 | 1.526 | 1.521 | 1.524 | 1.606 | 1.527 |

<Footnotes for Tables 1 and 2>

(A)-1: 9,9-bis[4-(2-acryloyloxyethoxyl)phenyl]fluorene

(A)-2: acrylic acrylate [raw material monomer composition (mass %): GMA (26)/acrylic acid (14)/MMA (60), mass average molecular weight (Mw): 30,000]

(A)-3: urethane acrylate [raw material monomer composition (equivalent weight): TDI (2)/HEA (2)/ethylene oxide-modified bisphenol A-type diol (EO=2 mol), liquid refractive index: 1.582]

(A)-4: bisphenol A-type EO-modified diacrylate (EO=4 mol)

(A)-5: phenylbenzyl acrylate

(A)-6: o-phenylphenoxyethyl acrylate

(A)-7: phenoxyethyl acrylate

(B)-1: benzophenone

(B)-2: 4-phenylbenzophenone

(B)-3: 4-benzoyl 4′-methyldiphenyl sulfide

(B)-4: 1-[4-(4-benzoylphenylsulfanyl)phenyl]-2-methyl-2-(4-methylphenylsulfonyl)propane-1-one

(C)-1: TPO (ethyl (2,4,6-trimethylbenzoyl)phenylphosphinate)

(D)-1: polyether acrylate (silicone additive “TEGORAD 2200N” produced by Evonik)

(D)-2: acrylic group-containing polyether-modified dimethylsiloxane (silicone additive “BYK-UV 3500” produced by BYK)

(D)-3: polyether-modified polydimethylsiloxane (silicone additive “BYK-333” produced by BYK)

(D)-4: silicone additive SH-29PA (produced by Dow Corning Toray)

1. A photocurable molding resin composition containing a photopolymerizable substance (A) having a (meth)acryloyl group in the molecule thereof; a hydrogen abstraction type photopolymerization initiator (B); an intramolecular cleavage type photopolymerization initiator (C); and a silicone compound (D), wherein the proportion of the silicone compound (D) is 1.0 to 5.0 parts by mass to the total mass of the composition that is 100 parts by mass of the constituents (A) to (C).

2. The photocurable molding resin composition according to claim 1, wherein the silicone compound (D) has a polymerizable unsaturated double bond in the molecule thereof.

3. The photocurable molding resin composition according to claim 1, wherein the proportions of the hydrogen abstraction type photopolymerization initiator (B) and the intramolecular cleavage type photopolymerization initiator (C) are 1.0 to 10 parts by mass and 0.5 to 10 parts by mass, respectively, relative to the total mass of the composition that is 100 parts by mass of the constituents (A) to (C).

4. The photocurable molding resin composition according to claim 1, wherein the photopolymerizable substance (A) having a (meth)acryloyl group in the molecule thereof is a di(meth)acrylate having a fluorene skeleton.

5. The photocurable molding resin composition according to claim 1, wherein the photopolymerizable substance (A) having a (meth)acryloyl group in the molecule thereof is urethane (meth)acrylate.

6. The photocurable molding resin composition according to claim 1, wherein the photopolymerizable substance (A) having a (meth)acryloyl group in the molecule thereof is an acrylic acrylate compound.

7. The photocurable molding resin composition according to claim 1, wherein the photopolymerizable substance (A) having a (meth)acryloyl group in the molecule thereof is a (meth)acrylic monomer.

8. A molded multilayer article produced by shaping the composition as set forth in claim 1 so as to firmly adhere to a transparent resin substrate, and curing the composition.

9. The molded multilayer article according to claim 8, wherein the transparent resin substrate is made of a material selected from the group consisting of acrylic resins, polycarbonate resins, polyester resins, polystyrene resins, fluororesins, and polyimide resins.

10. A molded multilayer article produced by shaping the composition as set forth in claim 2 so as to firmly adhere to a transparent resin substrate, and curing the composition.

11. A molded multilayer article produced by shaping the composition as set forth in claim 3 so as to firmly adhere to a transparent resin substrate, and curing the composition.

12. A molded multilayer article produced by shaping the composition as set forth in claim 4 so as to firmly adhere to a transparent resin substrate, and curing the composition.

13. A molded multilayer article produced by shaping the composition as set forth in claim 5 so as to firmly adhere to a transparent resin substrate, and curing the composition.

14. A molded multilayer article produced by shaping the composition as set forth in claim 6 so as to firmly adhere to a transparent resin substrate, and curing the composition.

15. A molded multilayer article produced by shaping the composition as set forth in claim 7 so as to firmly adhere to a transparent resin substrate, and curing the composition.
